(19) United States
(12) Patent Application Publication
(10) Pub. No.: US 2022/0143678 A1
(43) Pub. Date: May 12, 2022

(54) Rebar Tying Robot

(71) Applicant: GEM Technologies, Inc., Knoxville, TN (US)

(72) Inventors: Michael H. Evans, Knoxville, TN (US); Jason M. Evans, Knoxville, TN (US); Jayan K. Duggal, Knoxville, TN (US)

(21) Appl. No.: 17/521,459

(22) Filed: Nov. 8, 2021

Related U.S. Application Data
(60) Provisional application No. 63/110,644, filed on Nov. 6, 2020.

(51) Int. Cl. B21F 7/00; B25J 5/00; B25J 11/00

(52) U.S. Cl. CPC B21F 7/00; B25J 11/005; B25J 5/007

(57) ABSTRACT

A rebar tying system including a main body with a central opening that passes from top to bottom of the main body, two or more propulsion members coupled to the main body and configured to propel the rebar tying system over a rebar mat, and a plurality of rebar tying gun holders coupled to the main body, the rebar tying gun holders configured to each receive a rebar tying gun, and configured to be selectively positionable both horizontally and vertically in the central opening to perform rebar tying operations

### CROSS-REFERENCE TO RELATED APPLICATIONS

This application claims the benefit of U.S. Provisional Patent Application Ser. No. 63/110,644, filed on Nov. 6, 2020, which is incorporated herein in its entirety by reference.

### FIELD OF INVENTION

The present general inventive concept relates to rebar tying systems, and, more particularly, to a rebar tying system with a tank structure body having a plurality of rebar tying guns.

### BACKGROUND

The act of tying rebar together at intersections of a rebar mat is both difficult and very time consuming. In the past a worker had to tie the rebar together at each required intersection by hand. More recently, rebar tying guns have been developed to increase the convenience and speed with which a worker can make such ties. However, because a worker must still physically access each intersection point with the rebar tying gun, there is still a relatively large amount of inconvenience and time consumption, as it is exceedingly difficult for the worker to navigate his or her way to the various points of the rebar mat. Thus, there exists a need for an automated system that would increase the efficiency of the rebar tying operation by eliminating a worker from having to go from point to point to facilitate the rebar ties.

### BRIEF SUMMARY

According to various example embodiments of the present general inventive concept, a construction robot is provided to move over a rebar mat and tie rebars together at desired rebar intersections on the rebar mat. Various example embodiments of the present general inventive concept provide a plurality of rebar tying gun holders that are able to be positionally adjusted independently from one another so as to perform tying operations on rebar mats of various sizes of rebar spacing.

Additional aspects and advantages of the present general inventive concept will be set forth in part in the description which follows, and, in part, will be obvious from the description, or may be learned by practice of the present general inventive concept.

The foregoing and/or other aspects and advantages of the present general inventive concept may be achieved by providing a rebar tying system including a main body with a central opening that passes from top to bottom of the main body, two or more propulsion members coupled to the main body and configured to propel the rebar tying system over a rebar mat, and a plurality of rebar tying gun holders coupled to the main body, the rebar tying gun holders configured to each receive a rebar tying gun, and configured to be selectively positionable both horizontally and vertically in the central opening to perform rebar tying operations.

The foregoing and/or other aspects and advantages of the present general inventive concept may also be achieved by providing a rebar tying system including a chassis with a central opening that passes through the chassis from top to bottom of the chassis, continuous track assemblies respectively arranged on two opposing sides of the chassis and configured to propel the rebar tying system over a rebar mat, a linear actuator assembly coupled to the chassis, and a plurality of rebar tying gun holders coupled to the linear actuator assembly, the rebar tying gun holders configured to each receive a rebar tying gun, wherein the linear actuator assembly is configured to selectively move the rebar tying gun holders bidirectionally and independently from one another in a horizontal direction substantially parallel to a longitudinal direction of the chassis, and wherein the linear actuator assembly is configured to selectively move the rebar tying gun holders bidirectionally in a vertical direction through the central opening to move the rebar tying gun holders toward and away from a position underneath the chassis.

Other features and aspects may be apparent from the following detailed description, the drawings, and the claims.

### BRIEF DESCRIPTION OF THE FIGURES

The following example embodiments are representative of example techniques and structures designed to carry out the objects of the present general inventive concept, but the present general inventive concept is not limited to these example embodiments. In the accompanying drawings and illustrations, the sizes and relative sizes, shapes, and qualities of lines, entities, and regions may be exaggerated for clarity. A wide variety of additional embodiments will be more readily understood and appreciated through the following detailed description of the example embodiments, with reference to the accompanying drawings in which:

FIGS. 1A-1F respectively illustrate various views of a rebar tying robot according to an example embodiment of the present general inventive concept, with FIG. 1A being an upper perspective view, FIG. 1B being a lower perspective view, FIG. 1C being a front view, FIG. 1D being a side view, FIG. 1E being a top view, and FIG. 1F a bottom view of the rebar tying robot;

FIG. 2 illustrates a partially exploded view of the rebar tying robot of FIGS. 1A-F;

FIGS. 3A-B illustrate assembled and partially exploded perspective views of the linear actuator assembly of FIGS. 1A-F;

FIG. 4 illustrates a partially exploded perspective view of the vertical actuator assembly of FIGS. 3A-B;

FIG. 5 illustrates a partially exploded view of the horizontal actuator assembly of FIGS. 3A-B;

FIGS. 6A-B illustrate perspective views of the sensor assemblies of FIGS. 1A-F according to an example embodiment of the present general inventive concept;

FIGS. 7A-C illustrate portions of the operation of the rebar tying robot of FIGS. 1A-F according to an example embodiment of the present general inventive concept;

FIGS. 8A-B respectively illustrate the maximum and minimum distances at which the rebar tying guns may be placed away from one another in an example embodiment of the present general inventive concept;

FIGS. 9A-C illustrate three possible angles at which the rebar gun holders may be set relative to a rotational axis of the rebar gun holders;

FIGS. 10A-B illustrate assembled and partially exploded views of a rebar tying robot with a chassis cover according to an example embodiment of the present general inventive concept; and

FIGS. 11-13B illustrate various rebar tying operations performed by the rebar tying robot according to various example embodiments of the present general inventive concept.

### DETAILED DESCRIPTION

Reference will now be made to the example embodiments of the present general inventive concept, examples of which are illustrated in the accompanying drawings and illustrations. The example embodiments are described herein in order to explain the present general inventive concept by referring to the figures.

The following detailed description is provided to assist the reader in gaining a comprehensive understanding of the structures and fabrication techniques described herein. Accordingly, various changes, modification, and equivalents of the structures and fabrication techniques described herein will be suggested to those of ordinary skill in the art. The progression of fabrication operations described are merely examples, however, and the sequence type of operations is not limited to that set forth herein and may be changed as is known in the art, with the exception of operations necessarily occurring in a certain order. Also, description of well-known functions and constructions may be simplified and/or omitted for increased clarity and conciseness.

Note that spatially relative terms, such as “up,” “down,” “right,” “left,” “beneath,” “below,” “lower,” “above,” “upper” and the like, may be used herein for ease of description to describe one element or feature's relationship to another element(s) or feature(s) as illustrated in the figures. Spatially relative terms are intended to encompass different orientations of the device in use or operation in addition to the orientation depicted in the figures. For example, if the device in the figures is turned over or rotated, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

According to various example embodiments of the present general inventive concept, a construction robot is provided to tie rebars used to form a rebar mat, such as a horizontal rebar mat. Such a robot may be referred to as a rebar tying system, rebar tying robot, etc., interchangeably throughout the descriptions herein. Various example embodiments of the present general inventive concept may be configured as a tank structure-based robot equipped with two rebar tying guns, or rebar guns, for rebar tying, though other various example embodiments may include fewer or more rebar guns. In various example embodiments that are described and illustrated in several drawings discussed herein, the tank structure-based robot may be equipped with two rebar guns for rebar tying, the rebar guns each being held in rebar gun holders that can move independently from one another so as to vary the distance between the two rebar tying guns to allow to rebar intersections to be tied at the same time, or same position of the construction robot.

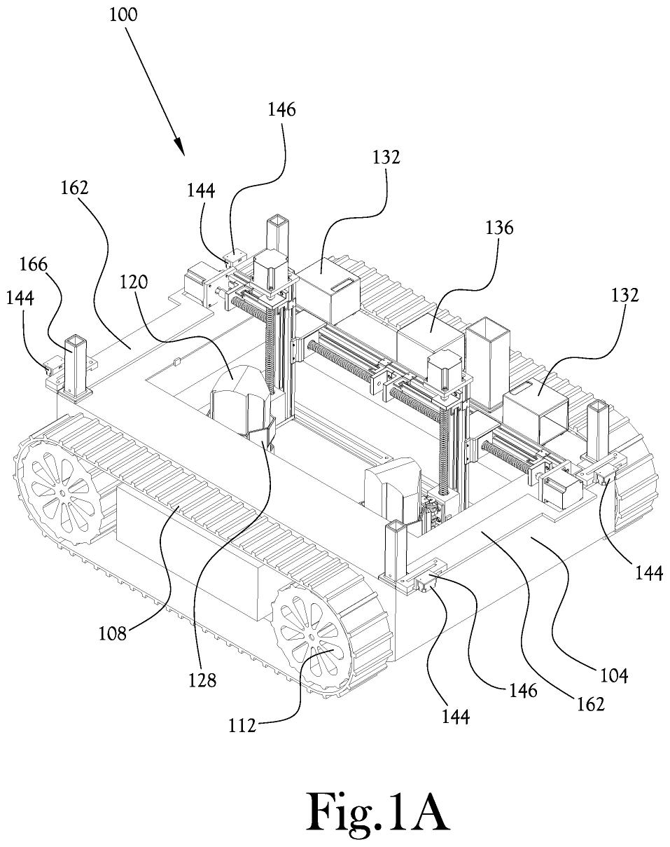

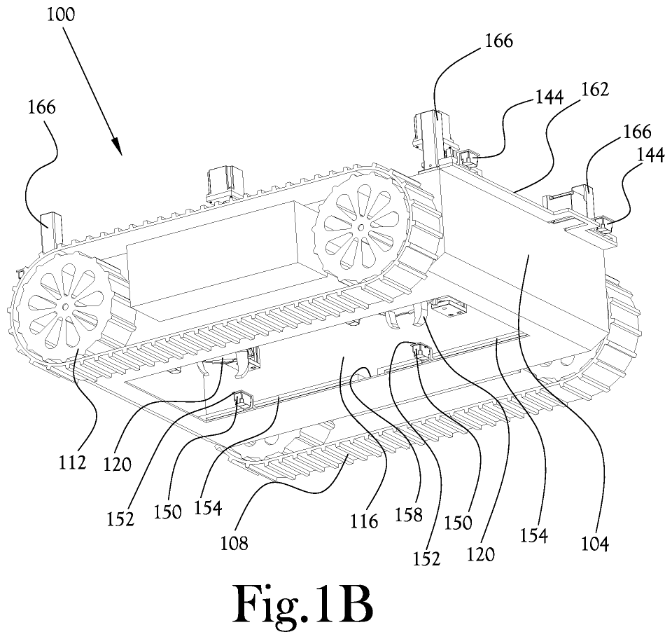

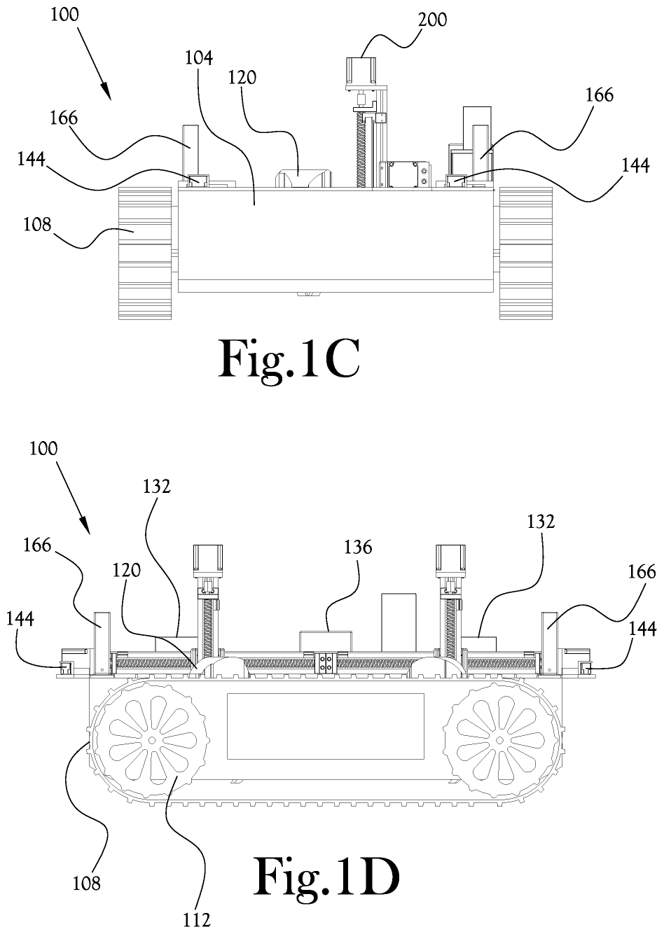

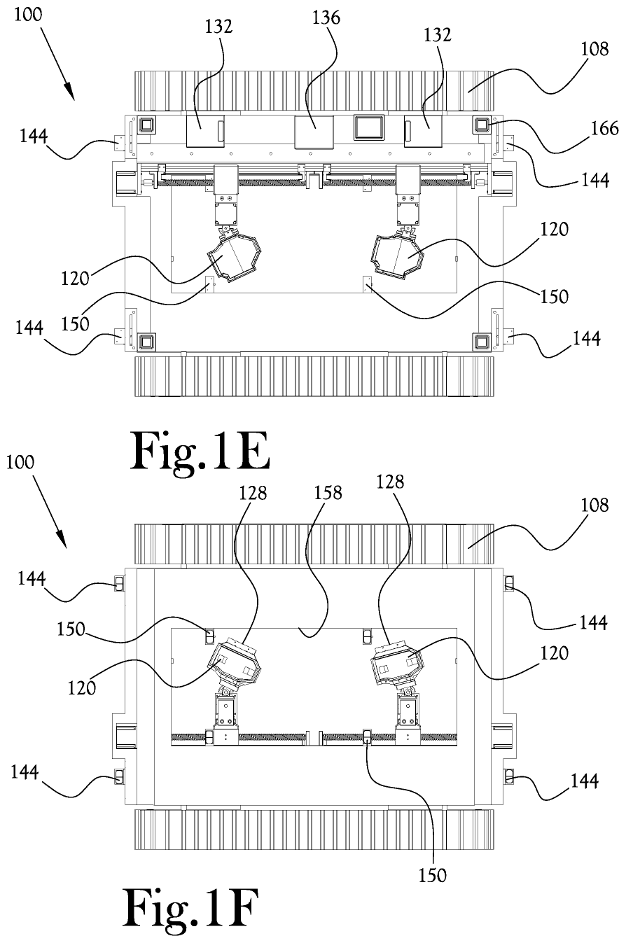

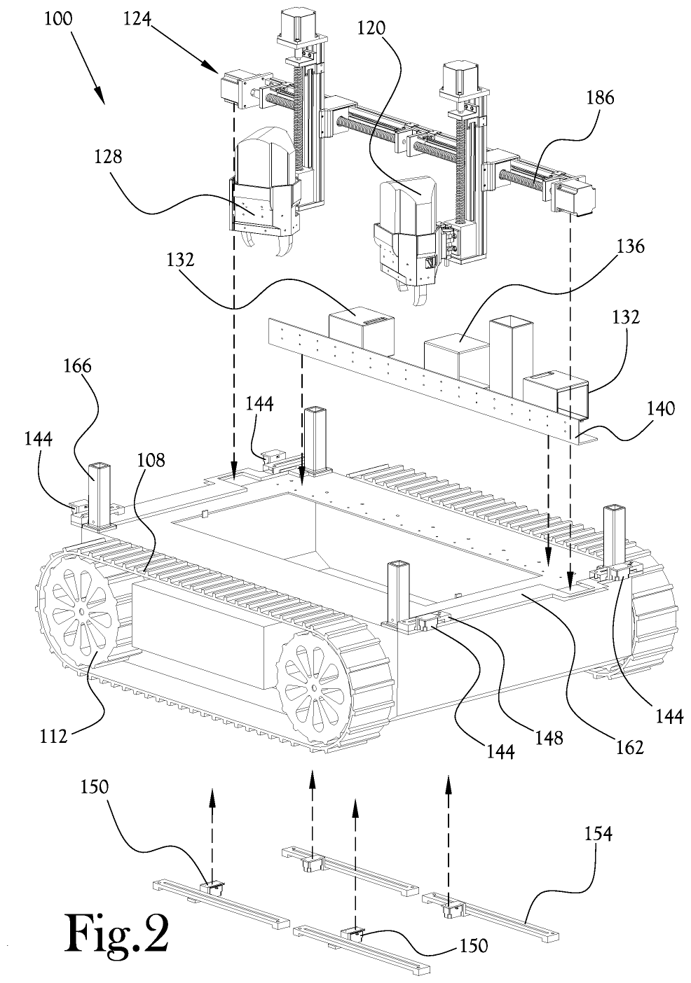

FIGS. 1A-1F respectively illustrate various views of a rebar tying robot according to an example embodiment of the present general inventive concept, with FIG. 1A being an upper perspective view, FIG. 1B being a lower perspective view, FIG. 1C being a front view, FIG. 1D being a side view, FIG. 1E being a top view, and FIG. 1F a bottom view of the rebar tying robot. FIG. 2 illustrates a partially exploded view of the rebar tying robot of FIGS. 1A-F. The rebar tying robot, or rebar tying system, 100 of this example embodiment includes a main body or chassis 104 that may be configured as a tank-based structure chassis. The chassis 104 is provided with a plurality of propulsion members to move the robot 100 along the rebar mat, which in this example are a pair of tank treads or continuous tracks 108 respectively provided on each side of the chassis 104, each of the continuous tracks 108 configured to move about a pair of wheels 112 configured to drive the respective tracks 108. In various example embodiments the tracks 108 may be a rubber tread/track designed for the tank structure chassis 104, and the wheels 112 may be various types of wheels/sprockets configured for the tank structure chassis 104. The driving componentry used to drive the wheels 112, and therefore, the tracks 112, may be located inside the chassis 104. As such wheel driving machinery is well known in the art, it has been omitted from the drawings for the sake of clarity. The chassis 104, which may be formed with, for example, aluminum, has a central opening 116 or cutout that passes through an entirety of the chassis 104 to provide operating room for a plurality of rebar tying guns 120 to be maneuvered in horizontal and vertical directions to perform rebar tying operations. The rebar tying guns 120 are moved in the horizontal and vertical directions for positioning and operation by a linear actuator assembly 124 that is mounted to a top of the chassis 104, and that is configured to independently move a pair of rebar gun holders 128 configured to hold the respective rebar tying guns 120 forward and back, and up and down, relative to the chassis 104. Thus, the rebar tying guns 120 can be spaced apart from one another at a same distance as the span between intersections in the rebar mat, and the robot 100 is able to travel over a row of rebar intersections to be tied, the rebar tying guns 120 being moved down to tie two rebar intersections at the same time when the rebar guns 120 are located over those intersections.

One or more battery mounts 132 may be provided to the chassis 104 to secure batteries to power the various systems and electronics of the robot 100. In the example embodiment of FIGS. 1A-F, two such battery mounts 132 are provided on one side of the chassis 104, and a controller enclosure or box 136 is provided on the chassis 104 between the battery mounts 132. The battery mounts 132 may be configured as an enclosure that holds the rebar guns' 120 battery or batteries, and may be designed in a manner such that the battery (batteries) can be easily removed. In various example embodiments the controller box 136 may be configured to hold a controller board, drivers, and other electronics used in operation of the rebar tying robot 100. The electrical connections and other such wirings for the electrical communication between the components have been omitted in these drawings for the sake of clarity. Such wiring may be located inside the chassis 104, arranged along the exterior of the chassis 104, or may be a combination of both. The batteries, which are not shown in these drawings, may be, for example, two LiFePo4 rechargeable batteries. An L bar bracket 140, which may be formed of aluminum, is provided on the chassis 104, proximate the battery mounts 132 and controller box 136, to provide a connecting support to the linear actuator assembly 124. The linear actuator assembly 124 may be coupled to the L bar bracket 140 by way of a plurality of securing members such as, for example, screws and nuts. The screw holes may be made in linear patterns on the vertical and horizontal face to hold the linear actuator assembly 124 efficiently, avoiding any bends and stress/strains. It is noted that various different example embodiments may have different arrangements of such components as these and others described herein, as well as more, fewer, or different components, without departing from the scope of the present general inventive concept. For example, a single battery mount may be needed with various example embodiments, controller circuitry may all be arranged inside the chassis, and so on.

One or more sensors 144, which may be referred to herein as navigational sensors 144, may be arranged on each end of the chassis 104 to detect rebar as the robot 100 moves over the rebar mat. Each of the navigational sensors 144 may be slidably coupled to a rail bracket 148 such that the respective navigational sensors 144 can be adjusted bidirectionally in a lateral direction relative to the chassis 104. As such, a worker can manually adjust the location of the sensors to correspond to different rows of rebar regardless of the spacing between the rebar in a lateral direction relative to the chassis 104. The controller can control the tracks 108 to keep the robot 100 in line over the row of rebar on which intersections are being tied according to feedback from the navigational sensors 144 sensing any movement away from the rebars over which they are positioned, which will typically be adjacent either side of the rebar row on which the tying operations are being currently performed. One or more sensors 150, which may be referred to herein as intersection sensors 150, may be arranged proximate edges of the central opening 116 to provide detection of rebar intersections that are to be tied, or not tied, by the rebar tying guns 120. In the example embodiment illustrated in FIGS. 1A-F, two intersection sensors 150 are provided on each side, and near the bottom, of the central opening 116. Each of the intersection sensors 150 are slidably coupled to a respective rail bracket 154 affixed to the chassis 104 such that the respective intersection sensors 150 can be adjusted bidirectionally in a longitudinal direction relative to the chassis 104. Thus, as with the navigational sensors 144, the locations of the intersection sensors 150 can be manually adjusted to correspond to different spans between the rebar in the longitudinal direction relative to the chassis 104. The intersection sensors 150 then detect rebar that lie perpendicularly to the direction of movement of the robot 100 to indicate that the rebar guns 120 are located over intersections, so that the robot 100 may be stopped and a typing operation performed. In this example embodiment, the central opening 116 is formed with a ledge 158 extending about the bottom of the central opening 116, and the rail brackets 154 are attached to an upper surface of the ledge 158. In other example embodiments, such a ledge 158 may not be provided to the chassis 104, and rail brackets could be attached to the vertical walls of the central opening 116, or a bottom surface of the chassis 104, to hold the intersection sensors 150 in place. The rail brackets 148 supporting the navigational sensors 144 in this example embodiment are attached to corresponding mounting brackets 162 attached to either end of the chassis 104 of the robot 100, but in various other example embodiments the rail brackets 148 or other such navigational sensor 144 supporting brackets could be mounted directly to the chassis 104. Four cover mounts 166 may be respectively arranged proximate the upper corners of the chassis 104 for the optional mounting of a chassis cover, which will be described herein.

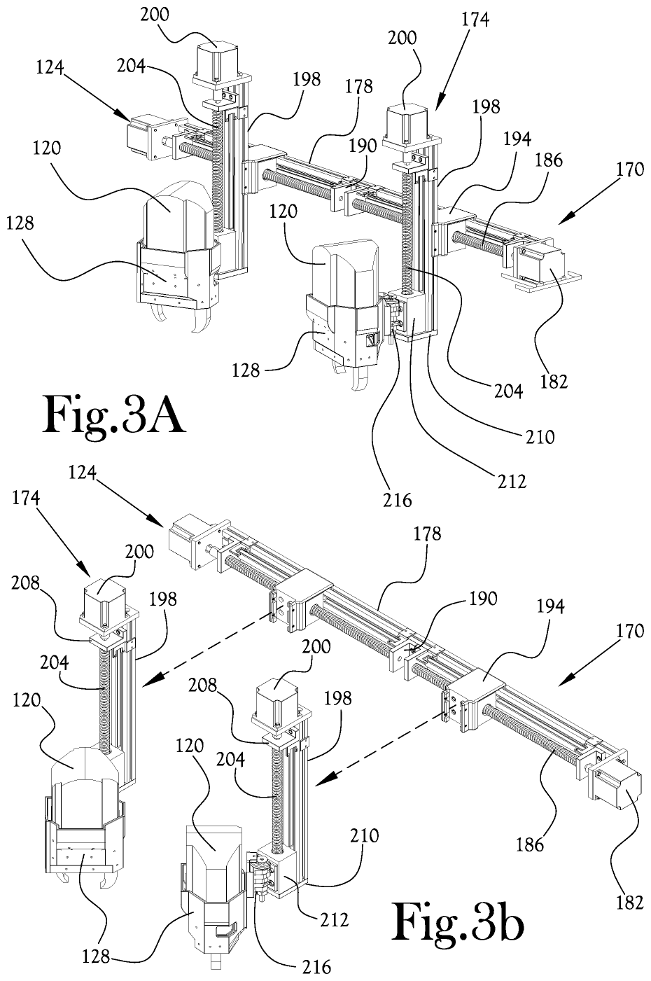

FIGS. 3A-B illustrate assembled and partially exploded perspective views of the linear actuator assembly 124 of FIGS. 1A-F. The linear actuator assembly 124 includes a horizontal actuator assembly 170, and a pair of vertical actuator assemblies 174 coupled to the horizontal actuator assembly 170. As previously described, the horizontal actuator assembly 170 is coupled to the L bar bracket 140 to be installed to the chassis 104 of the robot 100. The horizontal actuator assembly 170 includes a horizontal support rail 178 configured to be coupled to the L bar bracket 140. A pair of stepper motors 182 are respectively arranged proximate each end of the horizontal support rail 178, each configured to rotate a translation screw or leadscrew 186 that is connected to the respective stepper motors 182 at a first end of the leadscrew 186, and supported by leadscrew supports 190 at both ends. A rail coupling member 194 is arranged on each of the leadscrews 186. The rail coupling members 194 are configured to receive the respective leadscrews 186 such that the rail coupling members 194 may be moved back and forth along the leadscrews 186, and thus along the longitudinal axis of the robot 100, according to the direction of rotation of the leadscrews 186. The rail coupling members 194 are configured to be slidably coupled to the horizontal support rail 178 such that a fixed orientation of the rail coupling members 194 is maintained during such horizontal movement. Each of the vertical actuator assemblies 174 includes a vertical support rail 198 configured to be coupled to the respective rail coupling members 194 arranged on the leadscrews 186 of the horizontal actuator assembly 170. A stepper motor 200 is arranged proximate a top end of the vertical support rail 198, and is configured to be connected to a leadscrew 204 arranged in a vertical orientation. The leadscrew 204 is supported by a top leadscrew support 208 and a bottom leadscrew support 210, and is arranged to be rotated bidirectionally by the stepper motor 200. A rail coupling member 212 is arranged on each of the leadscrews 204. The rail coupling members 212 are configured to receive the respective leadscrews 204 such that the rail coupling members 212 may be moved up and down along the leadscrews 204 according to the direction of rotation of the leadscrews 204. The rail coupling members 212 are configured to be slidably coupled to the vertical support rail 198 such that a fixed orientation of the rail coupling members 212 is maintained during such vertical movement. The rail coupling members 212 are also configured to each be coupled to a rebar gun aligner 216 that is also coupled to one of the rebar gun holders 128. Therefore, during operation of each of the vertical actuator assemblies 174, when the stepper motor 200 rotates the leadscrew 204, the attached rebar gun holder 128 moves up or down depending on the direction of rotation, thus moving the rebar tying guns 120 up and down. It will be understood that although a stepper motor and leadscrew configuration is described in this example, any of a host of different linear actuators may be employed without departing from the scope of the present general inventive concept.

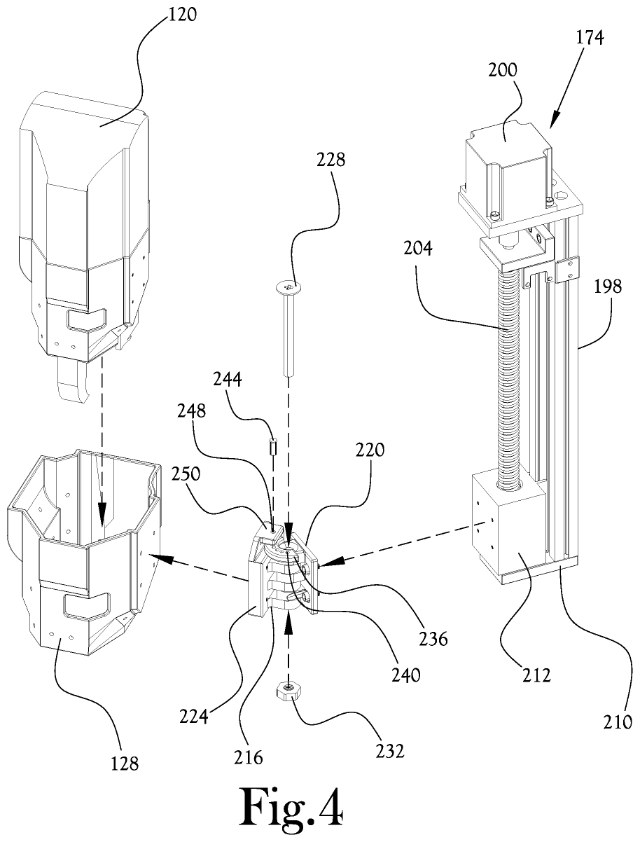

FIG. 4 illustrates a partially exploded perspective view of the vertical actuator assembly 174 of FIGS. 3A-B. As illustrated in this example embodiment, the rebar gun aligner 216 of the vertical actuator assembly 174 is a hinge or pivoting assembly including a first portion 220 configured to be coupled to the rail coupling member 212, and a second portion 224 configured to be coupled to the rebar gun holder 128. In this example embodiment the first portion 220 and second portion 224 form a hinge assembly that is held together by a bolt 228 and nut 232 that form the rotation axis about which the second portion 224 pivots relative to the first portion 220. The second portion 224 is formed with a lip 250 extending away from the rebar gun holder 128, the lip 250 having an opening 248 formed to receive a stopping member that passes therethrough. The first portion 220 is configured with a positioning plate 236 proximate a top portion thereof, the positioning plate 236 having a plurality of openings 240 formed so as be respectively located under the opening 248 in the lip 250 depending on the rotational position of the second portion 224. Thus, a plurality of different rotational positions of the second portion 224, and therefore rebar gun holder 128, relative to the first portion 220 may be maintained by the stopping member 244 which passes through the opening 248 in the lip 250, and on through the positioning plate 236 opening 240 located under the opening 248 in the lip 250. To adjust the rotational angle of the rebar gun holder 128 relative to the rail coupling member 212 of the vertical actuator assembly 174, a user can simply pull up on the stopping member 244 so that it does not pass through the openings 248,240 in both the lip 250 and the positioning plate 266, rotate the rebar gun holder 128 to the desired rotational position, and then lower the stopping member 244 down through the corresponding openings 248,240, securing the rebar gun holder 128, and therefore the rebar gun 120, at that new rotational angle. As illustrated in FIG. 4, the rebar gun holder 128 effectively acts as a holster for rebar gun 120.

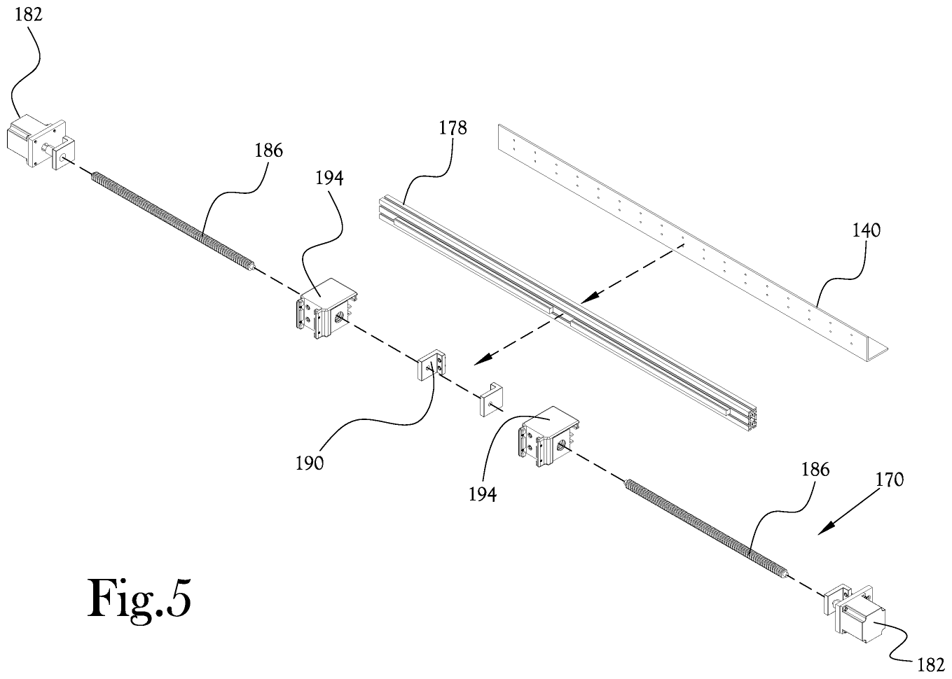

FIG. 5 illustrates a partially exploded view of the horizontal actuator assembly 170 of FIGS. 3A-B. As illustrated in this example embodiment, the two sub-assemblies of stepper motors 182, leadscrews 186, leadscrew supports 190, and rail coupling members 194 are arranged in substantial mirror images of one another on the horizontal support rail 178. Thus, the rail coupling members 194, and thus the entirety of the vertical actuator assemblies 174, can be moved independently from one another to positions as far apart as proximate each of the stepper motors 182, and as close together as proximate the leadscrew supports 190 at the distal ends of the leadscrews 186. Therefore, the rebar guns 120 can be custom set for a wide range of horizontal center to center distances of adjacent rows of rebar to perform the rebar tying process. In an example embodiment, the robot 100 can be set for a horizontal center to center distance in range of 11 inches (minimum) to 20 inches (maximum). The linear actuator assembly 124 may be used for maneuvering the rebar guns 120 in the vertical direction. For example, the linear actuator assembly 124 may be used to maneuver the rebar guns 120 in a vertical direction roughly 5 inches above the ground. The rebar gun aligner 216 may be used to align a rebar gun holder 128 at an angle so that a rebar tying job can be performed. For example, the rebar gun holder 128 may be aligned at 45 degrees, and may hold the alignment angle manually, with the help of the stopping member. In various example embodiments, the rebar gun holder 128 may be specifically configured for the desired rebar tying guns to be used, and may have a safety slot on the top for the initial rebar tie wire feed from rebar tie spool of the rebar gun 120. The rebar guns 120 may be modified for the robot construction and to reduce weight, as well as space occupied by the rebar guns 120, to automate the rebar guns 120, and to maneuver the rebar guns 120 in an efficient manner.

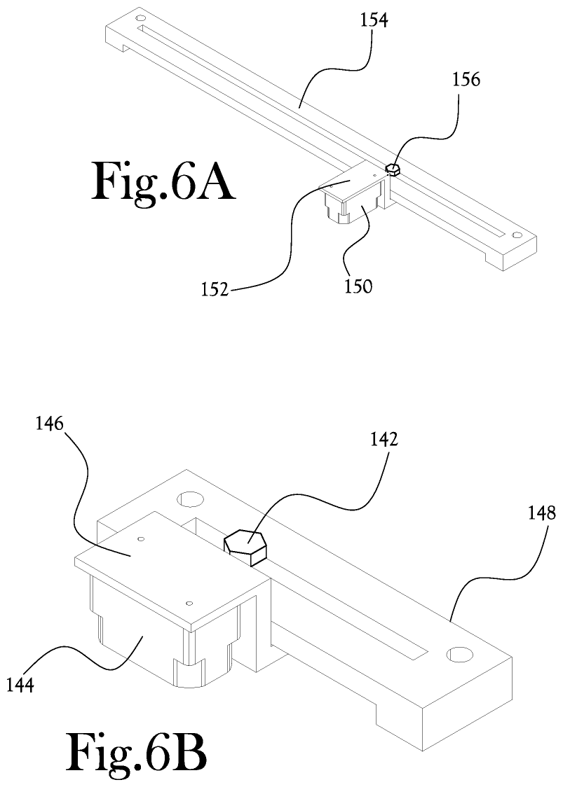

FIGS. 6A-B illustrate perspective views of the sensor assemblies of FIGS. 1A-F according to an example embodiment of the present general inventive concept. As illustrated in FIG. 6A, the intersection sensor 150 is slidably coupled to the rail bracket 154 through a sensor mount 152 that has a portion extending under the rail bracket 154. The rail bracket 154 may be, for example, a 14.25 inch by 1.20 inch linear rail. The portion of the of the sensor mount 152 under the central opening of the rail bracket 154 is configured to receive a position setting member 156, such as a screw or bolt, that interacts with the rail bracket 154 to secure the sensor mount 152, and therefore the intersection sensor 150, in the desired position along the rail bracket 154 to adjust sensor placement to accurately detect the rebar intersection. In various example embodiments the sensors may be LIDAR sensors, e.g., TF mini plus LIDARS which include an optical beam transmitter and an optical detector inside a 1.38 inch by 0.83 inch by 1.73 inch arrangement to gather optical information. The optical information may then be analyzed by an analyzer of the controller to indicate the position of rebar, so that the robot can stop and maneuver the rebar guns to tie the rebar intersection. Similarly, as illustrated in FIG. 6B, the navigational sensor 144 is slidably coupled to the rail bracket 148 through a sensor mount 146 that has a portion extending under the rail bracket 148. The rail bracket 148 may be, for example, a 4.38 inch by 1.20 inch linear rail. The portion of the of the sensor mount 146 under the central opening of the rail bracket is configured to receive a position setting member 142 that interacts with the rail bracket 148 to secure the sensor mount 146, and therefore the navigational sensor 144, in the desired position along the rail bracket 148. Thus, a user can simply loosen the respective position setting member of the respective sensor assemblies, slide the sensor to the desired position according to the rebar configuration to be worked on, and then re-tighten the position setting member to secure the sensor in that position. The navigational sensors may be used to detect the end of the rebar mat so as to stop the robot or start a turning or other such reorientation process. It will be understood that such a sensor may be mounted and/or adjusted in a host of different ways without departing from the scope of the present general inventive concept.

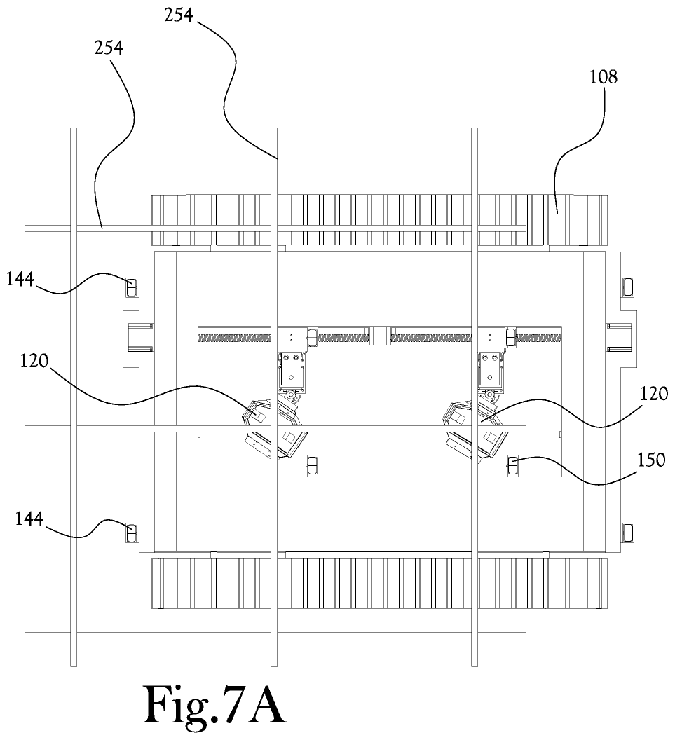

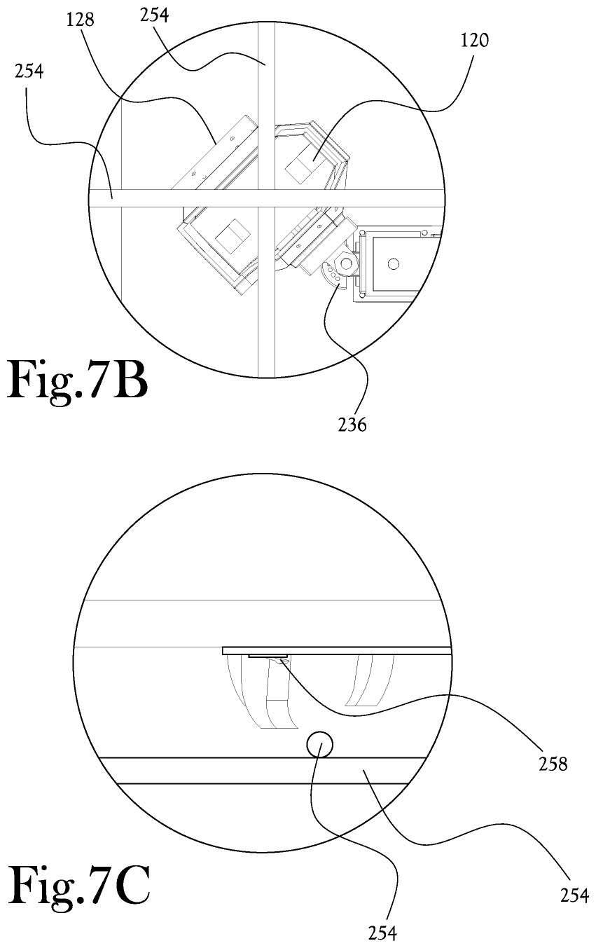

FIGS. 7A-C illustrate portions of the operation of the rebar tying robot 100 of FIGS. 1A-F according to an example embodiment of the present general inventive concept. As illustrated in FIG. 7A, the robot 100 is being prepared to move over a mat formed of a plurality of rebars 254 with intersections to be tied. In this example, the robot 100 may be powered by one or both of two rechargeable batteries. In this example embodiment positioning of the robot 100 is performed with a remote control (RC), but in various example embodiments the robot 100 can be used with the sensors described herein along with, or instead of, such a remote control. In this example embodiment, an operator may turn on the ON switches of the robot 100 and an RC transmitter, and maneuver the robot 100 towards a starting point of the rebar 254 mat by using the RC transmitter manually, at which point the robot 100 may start traversing the mat. The human operator may switch the robot 100 operation to “Center Alignment Mode” and align the rebar tying guns 120 using the RC transmitter to the required center to center distance, which is the distance between centers of two adjacent rebars 254. The human operator may then align the rebar guns at 45° with respect to the rebar 254 intersections, by revolving the rebar guns 120 and holders 128 with the aligner 216 at 45° with respect to rebar 254 intersection. After that the aligner 216 may be locked to the adjusted angle (45°), for example, by using the stopping member 244, which can be any of a host of securing members, such as, for example, an M2 screw. The human operator may then verify the alignment of the rebar guns 120 with respective rebar 254 intersections by determining whether the guns 120 are exactly vertically opposite to the rebar 254 intersection or not. After these alignments of the rebar tying guns 120, the robot 100 may be positioned manually using the RC transmitter correctly over the intersections. These alignments may be maintained throughout the entire rebar tying job. As illustrated in FIG. 7C, a limit switch (sensor) 258 may mounted on each of the rebar guns 120, proximate a bottom of the rebar guns between the arm and curl guide. The operator can start the rebar tying operation by switching the robot to “tying mode.” The rebar guns 120 will go downward and tie the rebar intersection as the limit switch 258 gets triggered by contacting the rebar 254 under the respective rebar guns 120. After few seconds the rebar guns 120 will retract. Thus, when vertical actuator assembly 174 moves the rebar gun holders 128 downward over a detected rebar intersection, which may be detected by the intersection sensors 150 in some example embodiments, or may be controlled by RC with other visual equipment such as cameras, the limit switch 258 of the respective rebar tying guns 120 contacts the rebar 254 and performs the tying operation on the intersection. After the tying operation is completed, or after a predetermined amount of time allowed for the tying operation, the vertical actuator assembly 174 raises the rebar gun holders 128 so that the robot 100 can move to the next desired rebar intersections. When using an RC, the operator may then switch back the operation to ARM mode, so that robot can move further to tie next alternate rebar intersection. In some example embodiments the robot 100 can tie the alternate rebars in a line along horizontal row. The amount of ties made may depend upon the percentage needed for the various jobs, and thus the intersections chosen for the tying operation will depend on that percentage. Various examples of different percentage tying operations are described herein.

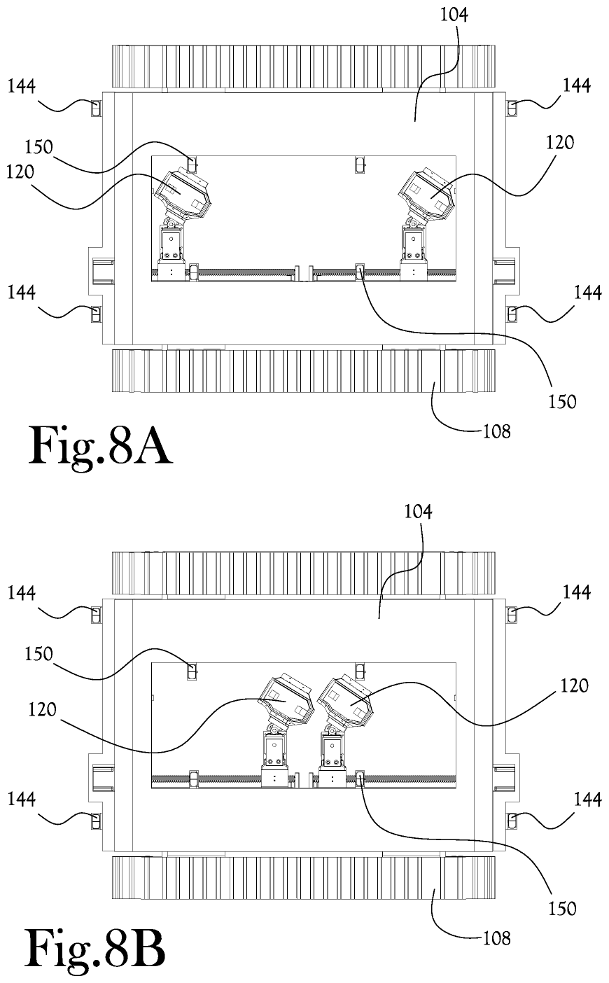

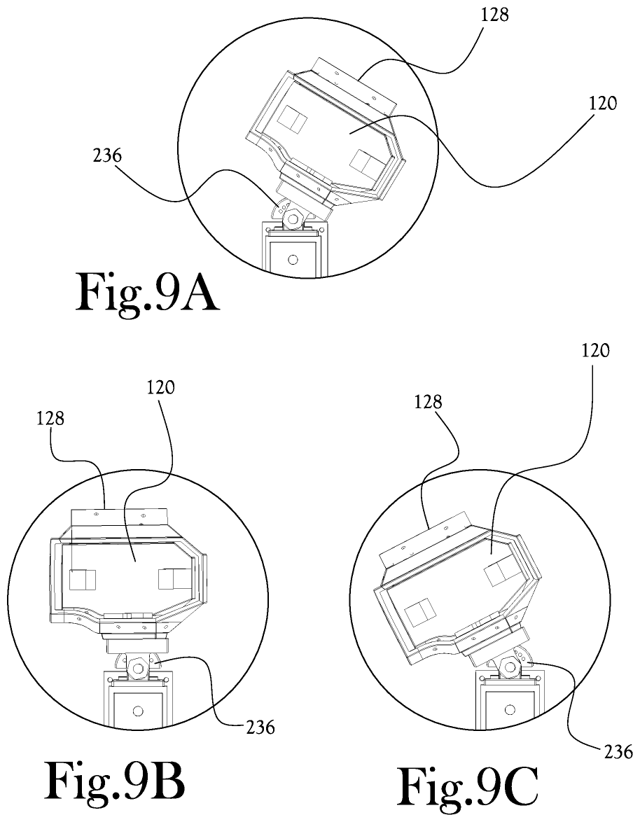

In typical applications the robot 100 may not be able tie the rebar intersections at boundary or at extreme ends, as they are unreachable for the robot 100, and/or can destabilize the robot 100. The robot 100 can tie the rebars inline along the horizontal rows, and along the vertical columns. In various embodiments, for example, the robot may tie rebars with a center to center distance ranging from 6 inches to 23 inches. The center to center distance is the distance in between centers of adjacent rebars in same direction. In another example, the center to center distance may be 16 inches. In such an example, the robot can start tying from intersection of the second row and second column of rebar 254. The robot can tie 2 rebars in the same attempt, as in 2nd row 2nd-3rd rebars, then move and tie the 6th-7th rebars, and so on. FIGS. 8A-B respectively illustrate the maximum and minimum distances at which the rebar tying guns 120 may be placed away from one another in an example embodiment of the present general inventive concept. As illustrated in FIG. 8A, although the rebar gun holders 128 are not necessarily moved to the opposing proximal limits of each of the horizontal actuator assemblies 170, the maximum distance between the rebar gun holders 128 is limited by the size of the bottom of the central opening 116. In other words, the rebar gun holders 128 still have to be able to travel downward without being impeded by the chassis 104 structure. As illustrated in FIG. 8B, the minimum distance between the rebar gun holders 128 can be achieved by moving the rebar gun holders 128 proximate the distal ends of each of the horizontal actuator assemblies 170. This minimum distance between the rebar gun holders 128 may also be affected by the angle at which the rebar gun holders 128 are set, as some angles may cause structural interference between the rebar gun holders 128 themselves before they are moved to the absolute distal limits of the horizontal actuator assemblies 170. FIGS. 9A-C illustrate three possible angles at which the rebar gun holders 128 may be set relative to a rotational axis of the rebar gun holders. As previously described, a worker is able to set the rebar gun holders 128 at a host of different angles according to the interaction between the positioning plate 236 and the stopping member 244, and in some example embodiments the number of possible positions is determined by the number of openings 240 in the positioning plate 236.

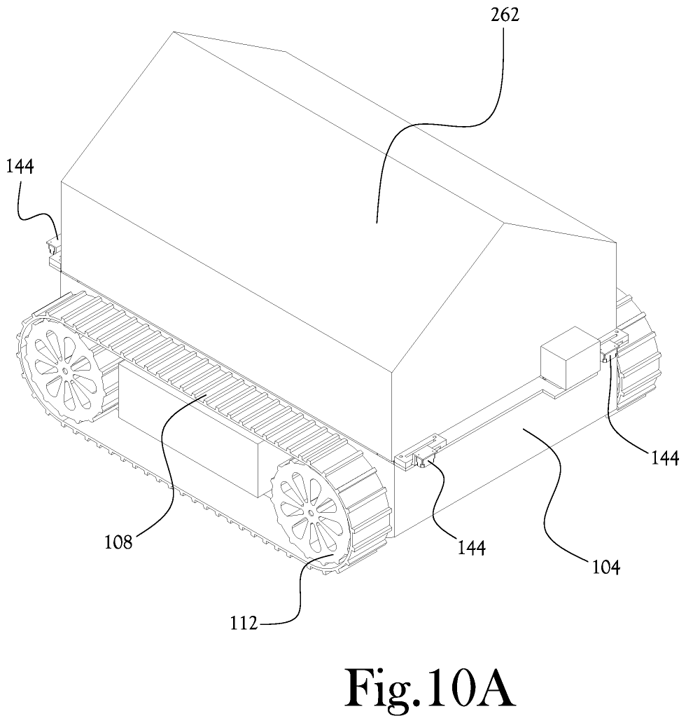

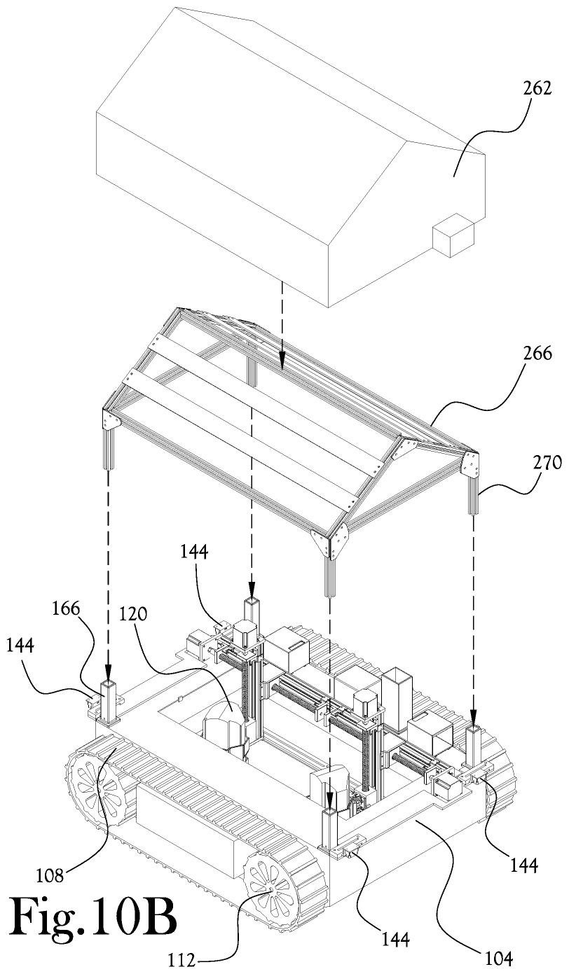

Various example embodiments of the present general inventive concept may provide a rebar tying robot with a chassis cover to protect the robot from various elements. FIGS. 10A-B illustrate assembled and partially exploded views of a rebar tying robot with a chassis cover 262 according to an example embodiment of the present general inventive concept. As illustrated in FIG. 10A, the robot 100 includes a chassis cover 262 that protects the robot 100 from weather and other conditions which could obstruct the operation ability of the various components of the robot 100. The chassis cover 262 can also protect the mechanical chassis of the robot 100 from rusting, maintain the optimal working environment for the internal robot sensors, provide a better aesthetic look for the robot, etc. FIG. 10B illustrates an exploded view of the robot 100 of FIG. 10A in which the cover 262 has been removed to expose a cover frame 266 configured to support the chassis cover 262. The cover frame 266 includes a plurality of cover frame posts 270 that are configured to be received in the cover mounts 166 attached to the chassis 104. The cover frame 266 may be shaped substantially similarly to the cover 262, and a plurality of frame joiners may be configured to join various parts of the top cover frame 266 together. Various example embodiments of the present general inventive concept may provide a host of different top cover configurations. For example, the top cover may be formed of a single rigid body that is attached or otherwise coupled to the chassis frame 1 without a skeletal frame. Other various example embodiments may provide a top cover with access panels or other such openings through which an operator may access the componentry under the top cover.

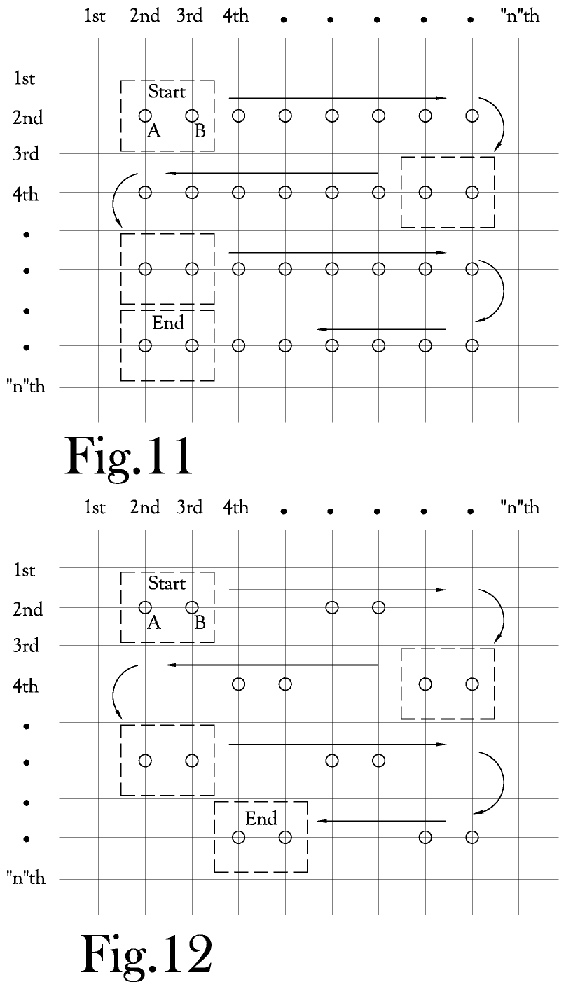

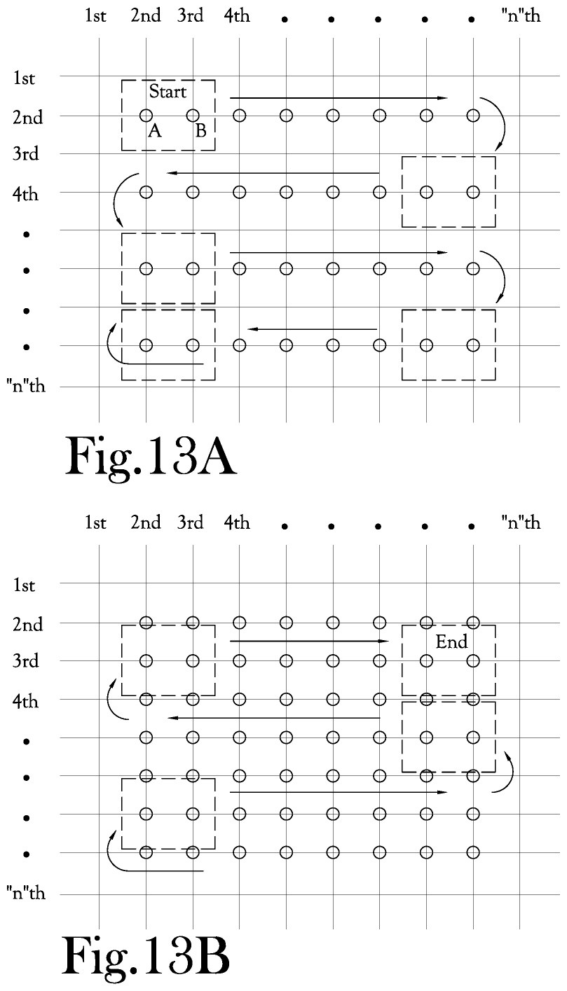

Several of rebar tying operations are described herein to show different examples of how the rebar tying robot 100 may be used. Human operators may make the necessary preparations for the rebar mat tying operation by the robot. For example, initially the human operators may tie the boundary rebar and/or their intersection points, as the robot cannot typically tie the boundary points. The human operator will then turn on the power switch located at the rear end of the robot and power on the RC transmitter in some example embodiments, and/or position the navigational and intersection sensors in some example embodiments. In various example embodiments the human operator may now arm the robot using an arm switch on an RC transmitter, and start maneuvering the robot 100 with the help of RC transmitter to the starting point of the rebar mat. Arming is a safety measure to avoid movement of robot accidentally. FIGS. 11-13B illustrate various rebar tying operations performed by the rebar tying robot according to various example embodiments of the present general inventive concept. As illustrated in FIG. 11, an operator may move the robot 100, such as by remote control or manually, to the first set of indexing points (A,B) for the initial calibration. Once the robot 100 is located over the initial indexing points, the operator may disarm, or turn off, the arm switch of the RC transmitter or other such movement controller to avoid any unwanted robot chassis movement. The operator may then center the navigational sensors 144 and intersection sensors 150, and set the rebar gun holders 128 to the correct angle for the rebar tying operation. The centering of the rebar gun holders 128 may be performed by the horizontal actuator assembly 170 by the controller based on signals from the intersection sensors 150. After the robot 100 is successfully positioned and aligned, the center to center remains fixed throughout an entire job. The usual center to center distance used is 16 inches, which is the center distance between two consecutive rebar parallel to each other. After positioning and alignment once for an entire job, all the index points set can be tied. The operator then verifies if both rebar guns are aligned with the index set points (A, B). The operator may adjust the robot accordingly with RC transmitter or manually to orient the rebar guns inline above the index set or intersection points (A, B). In various example embodiments the robot 100 is provided with a receiver to receive the control signals from the remote control, and to communicate the control signals to the controller controlling the system. The robot can now start tying the index set points (A, B) or rebar intersections. For tying, the operator may turn on the tying mode, for example, on a control panel on the robot 100 or by remote control. In the tying mode, both rebar guns will move down towards the index set points (A, B) or intersection points. When the rebar guns touch the index set or intersection points (A, B), the limit sensor 258 will be turned on, which will trigger the rebar guns 120 for tying the index set or intersection points (A, B). After a successful tying process, the rebar guns 120 will retract back to their original positions, moving upwards towards the motors 200. The tying process for the index set or intersection points (A, B) are now complete. The operator may then arm the robot again to start maneuvering to the next index points set, and repeat the previously described operations for the remaining index set points until the job is complete. As illustrated, N columns and N rows are formed by a plurality of rebars, with a host of intersections along the way. The outermost rows and columns of rebars form an effective border inside of which the robot will perform tying operations. The outermost intersections of the rebar mat, which may be considered as non-reachable points for the robot, may be tied by human operators as a part of preparation for the job. As illustrated, every other row of rebar inside the border may be skipped in this rebar tying operation, due to the number of ties desired being accomplished on the remaining rows. The circles on these intersections indicate the intersections which are tied by the robot 100 during the rebar tying operation. As illustrated, in this example the robot is positioned over the two intersections A and B that are in the top left corner of the mat and inside the “border,” which will be the starting point (marked “Start” in FIG. 11). After tying those two intersection points, the robot 100 is advanced along that row until the rebar tying guns 120 are positioned over the next two intersections to perform a tying operation there. The robot 100 proceeds thusly down the row, tying every intersection along that row inside the border. As illustrated, when the last two intersections are tied, the robot 100 is maneuvered to turn and move in the opposite direction along the row of rebars two rows down from the starting row, stopping to perform the tying operation at each consecutive pair of intersections. These operations are repeated until all four of the rows have each of the intersections within the border tied, as illustrated in FIG. 11, at which point the robot is located at the end point (marked “End”). In a normal tying case, an operator may only perform tying at every second or third intersection, depending upon the size and spacing of bars (or rebars), but with not less than three ties to any one bar. Thus, in typical construction only 10-25% of rebar tying is done, except for bridges. Considering the calculations for the example illustrated in FIG. 11, there are 90 total intersection points, of which 32 are successfully tied during the illustrated passes by the robot. There are 34 intersection points located along the border, which are not reachable by the robot 100, or are simply too inefficient to be tied by the robot 100. Therefore, the percentage of successful ties by the robot is 32/90 which equals 0.356, or approximately 36%. FIG. 12 illustrates a robot tying operation according to another example embodiment of the present general inventive concept. In the operation illustrated in FIG. 12, the robot 100 is used to perform only the minimum possible ties allowed by the project. Again, the circles indicate intersection points that will be tied. As illustrated in FIG. 12, the robot 100 starts in the upper left corner of the mat inside the border, and ties the two intersection points A and B under the initially positioned robot. The robot is then maneuvered along that row so as to skip the next two intersection points, and positioned for a tying operation over the two intersection points after the two skipped points. The robot is then moved to skip the next two points, before moving down two rows to come back in the opposite direction, repeating the tying of every other pair of intersection points along the applicable rows. This operation is repeated until the robot reaches the end point, which is two intersection points shorter in the last row in this example, due to the last two intersection points not being tied. So, for the same grid layout as shown in FIG. 11, in FIG. 12 the robot 100 only performs the tying operation at 16 of the 90 intersection tie points of the mat. It is noted again that 34 of the points, those located on the border, are considered not reachable by the robot 100, or inefficient points to tie. Thus, the percentage of successful ties by the robot 100 is 16/90 which equals 0.17778, or approximately 18%. FIGS. 13A-B illustrate a robot tying operation according to yet another example embodiment of the present general inventive concept. In the operation illustrated in FIGS. 13A-B, the robot 100 is used to perform the maximum possible ties for the given rebar mat portion inside the border. In this example embodiment, all of the intersection points inside the border will be tied. In FIG. 13A, the circles indicate intersection points that will be tied during a first pass (or forward pass) moving “down” the mat, and the remaining intersection points inside the border will be tied during a second pass (or reverse pass) moving back “up” the mat. The first pass of the robot 100 is illustrated in FIG. 13A. In FIG. 13B, which illustrates the second pass of the robot 100, the added circles indicate intersection points tied during the second pass. As illustrated in FIG. 13A, the robot 100 starts in the upper left corner of the mat inside the border, at the point marked “Start”, and ties the two intersection points A and B under the initially positioned robot 100. The robot is then maneuvered along that row, tying each consecutive pair of intersection points, until reaching the end of the row, at which point the robot is moved two rows down to come back in the opposite direction, as done in the previous examples. However, in this example, once the robot 100 has reached the tying position for the last two intersections of the bottom row inside the border, the robot 100 is then maneuvered back to the immediately adjacent row “above” that has not been tied, as indicated by the arrow in the bottom left hand corner of FIGS. 13A-B, and essentially reverses the movements of the heretofore performed operation to tie all of the remaining intersection points along the way back “up” the mat, as illustrated in FIG. 13B. As illustrated in FIG. 13B, the robot ends at the “End” position proximate the upper right corner of the mat, at the point at which the last two intersection points are tied. Thus, four passes are made “down” the mat, and three passes are made “up” the mat, covering each of the seven rows inside the border. In this example, 32 intersection points are tied in the forward execution run in FIG. 13A, and 24 intersection points are tied in the reverse execution run in FIG. 13B, for a total number of 56 intersection points tied out of the 90 intersection points of the mat. Again, as 34 of the intersection points are considered as not reachable by the robot, or inefficient points to tie, the number of successful ties by the robot is 56/90, which equals 0.62222, which may be rounded up to approximately 63%. Therefore, it is evident that such automated rebar intersection point tying by the robot greatly increases the efficiency and convenience of the job. Also, in various example embodiments the boundary intersection points might be possible to tie, except for perhaps the extreme corners, but in some cases may be at an expense of two or three times the time taken to complete the job inside the boundary. Therefore, such operations have not been included in the above calculations, as they are considered as being left untied by the robot, and rather tied by a human operator as a part of preparation for the job.

In various example embodiments the rebar guns may each be supported by a custom rebar gun holder and powered by two 6A 18.8V batteries. In various example embodiments the construction robot will be able to complete the rebar tying project on one charge of the batteries. An example embodiment according to the present general inventive concept may provide a construction robot weighing approximately 140 pounds, having approximate dimensions of 34 inches long, 29 inches wide, and 14 inches high. The robot of this example embodiment may have two rebar tying guns maneuvered by motors, e.g., NEMA 23 motors. The rebar guns may be maneuvered along a 29″ linear rail having two carriages, respectively supporting two 11.5″ rebar gun linear actuators/rails. The batteries may be LiFePO4 batteries. The robot may have a controller box comprising a plurality of limit sensors. The rebar gun holders may be arranged on respective rebar/vertical linear actuator/rails, the rebar guns being able to supply approximately 5,500 ties (#3×#3) per gun with a full charge of the respective 6A batteries. The robot may be controlled via an RC transmitter. The robot may further be dust proof and water splash proof.

Various example embodiments of the present general inventive concept may provide a robot that is equipped with sensors, such as proximity sensors and/or optical sensors which may be able to transmit video signals, to assist with the movement and positioning of the robot. For example, an operator may be able to facilitate movement of the robot with a remote control that is in communication with the robot, and which is able to display to the operator various positioning signals and/or optics. The robot may be configured to maneuver on the top of the rebar mat with initial preparation with the rebar ties manually done by iron workers for the non-reachable area of the robot, e.g., the areas at the extreme edges of the rebar mat. In some example embodiments, the robot can effectively perform 45-55% of ties efficiently on a rebar tying job. On an average, only 30-40% of intersection ties are required for normal rebar tying jobs. For example, one possible rebar mat size may be 12 feet×12 feet, with each “block” formed by the rows and columns of rebar in the mat being 12″ by 12″. A construction robot according to an example embodiment of the present general inventive concept may be approximately 36 inches long and 32 inches wide. In a first pass, the robot may move along every other row of rebar, and then move along the remaining rows in a second pass. The rebar bordering the rebar mat, or more precisely the boundary rebar intersections of the mat, can be tied by a human worker, as the robot may simply not have enough room for operation along the border of the mat.

Various example embodiments of the present general inventive concept may provide a rebar tying system including a main body with a central opening that passes from top to bottom of the main body, two or more propulsion members to propel the rebar tying system over a rebar mat, and a plurality of rebar tying guns configured to be selectively positionable both horizontally and vertically in the central opening to perform rebar tying operations. The system may further include a plurality of rebar tying gun holders configured to receive and hold the respective rebar tying guns. The system may further include a plurality of rebar tying gun aligners to which the rebar tying gun holders are respectively attached, the rebar tying gun aligners being configured to angularly position the rebar tying gun holders horizontally at a desired position over the rebar mat. The system may further include a plurality of vertical linear actuators to which the rebar tying gun aligners are respectively attached, the vertical linear actuators being configured to position the rebar tying gun holders to a desired vertical position. The system may further include a horizontal linear actuator to which the plurality of vertical linear actuators are respectively attached, the horizontal linear actuator being configured to position the vertical linear actuators to respective desired positions along a horizontal axis. The two or more propulsion members may include wheel and track assemblies provided respectively to each side of the main body. The system may further include a plurality of sensors configured to indicate positioning of the system relative to the rebar mat, and a controller to receive position signals from the sensors and control movement and positioning operations based thereon. The controller may be configured to communicate with a remote control to provide various sensor information and to receive various control commands.

Various example embodiments of the present general inventive concept may provide a rebar tying system including a main body with a central opening that passes from top to bottom of the main body, two or more propulsion members coupled to the main body and configured to propel the rebar tying system over a rebar mat, and a plurality of rebar tying gun holders coupled to the main body, the rebar tying gun holders configured to each receive a rebar tying gun, and configured to be selectively positionable both horizontally and vertically in the central opening to perform rebar tying operations. The system may further include a plurality of rebar tying guns respectively received in the rebar tying gun holders. The system may further include a linear actuator assembly coupled to the main body and the rebar tying gun holders, and configured to position the rebar tying gun holders independently from one another. The linear actuator assembly may include a horizontal actuator assembly having a horizontal support rail configured to be coupled to the main body, a first horizontal leadscrew, a first horizontal motor configured rotate the first horizontal leadscrew, a first horizontal rail coupling member configured be slidably coupled to the horizontal support rail so as to move along the first horizontal leadscrew bidirectionally according a rotational direction of the first horizontal leadscrew, and configured to be coupled to a first one of the rebar tying gun holders, a second horizontal leadscrew, a second horizontal motor configured rotate the second horizontal leadscrew, and a second horizontal rail coupling member configured be slidably coupled to the horizontal support rail so as to move along the second horizontal leadscrew bidirectionally according a rotational direction of the second horizontal leadscrew, and configured to be coupled to a second one of the rebar tying gun holders, wherein the first and second horizontal leadscrews are substantially aligned along a common longitudinal axis. The linear actuator assembly may further include a first vertical actuator assembly including a first vertical support rail configured to be coupled to the first horizontal rail coupling member, a first vertical leadscrew, a first vertical motor configured to rotate the first vertical leadscrew, and a first vertical rail coupling member configured to be slidably coupled to the first vertical support rail so as to move along the first vertical leadscrew bidirectionally according a rotational direction of the first vertical leadscrew, and configured to be coupled to the first one of the rebar tying gun holders; and a second vertical actuator assembly including a second vertical support rail configured to be coupled to the second horizontal rail coupling member, a second vertical leadscrew, a second vertical motor configured to rotate the second vertical leadscrew, and a second vertical rail coupling member configured to be slidably coupled to the second vertical support rail so as to move along the second vertical leadscrew bidirectionally according a rotational direction of the second vertical leadscrew, and configured to be coupled to the second one of the rebar tying gun holders. Each of the first and second vertical actuator assemblies may include a rebar gun aligner coupled between the respective vertical rail coupling members and rebar gun holders and configured to selectively rotate the respective rebar gun holders to a desired angle of rotation. The rebar gun aligner may be arranged as a hinge assembly having a plurality of possible fixed positions. A first portion of the hinge assembly may include a retractable stopping member, and a second portion of the hinge assembly may include a plurality of openings configured to respectively receive the stopping member to fix a desired rotational angle of the rebar gun holder. The system may further include a plurality of navigational sensors provided at one or both ends of the main body and configured to detect rebar that is oriented in a direction parallel to a longitudinal axis of the main body. Each of the navigational sensors may be configured to be slidably coupled to the main body so as to be positionally adjustable in a direction lateral to the longitudinal axis of the main body. The system may further include a plurality of intersection sensors provided proximate a bottom of the central opening and configured to detect rebar that is oriented lateral to a longitudinal axis of the main body. Each of the intersection sensors may be configured to be slidably coupled to the main body so as to be positionally adjustable in a direction parallel to the longitudinal axis of the main body. The system may further include a plurality of rebar tying gun aligners to which the rebar tying gun holders are respectively attached, the rebar tying gun aligners being configured to angularly position the rebar tying gun holders horizontally at a desired position over the rebar mat. The system may further include a plurality of vertical linear actuators to which the rebar tying gun aligners are respectively attached, the vertical linear actuators being configured to position the rebar tying gun holders to a desired vertical position. The system may further include a horizontal linear actuator to which the plurality of vertical linear actuators are respectively attached, the horizontal linear actuator being configured to position the vertical linear actuators to respective desired positions along a horizontal axis. The two or more propulsion members may be configured as continuous track assemblies provided respectively to each side of the main body. The system may further include a plurality of sensors configured to indicate positioning of the system relative to the rebar mat, and a controller to receive position signals from the sensors and control movement and positioning operations based thereon. The controller may be configured to communicate with a remote control to provide various sensor information and to receive various control commands. The sensors may be slidably mounted to the main body so as to be adjustable to position the respective sensors over respective rebars.

Various example embodiments of the present general inventive concept may provide a rebar tying system including a chassis with a central opening that passes through the chassis from top to bottom of the chassis, continuous track assemblies respectively arranged on two opposing sides of the chassis and configured to propel the rebar tying system over a rebar mat, a linear actuator assembly coupled to the chassis, and a plurality of rebar tying gun holders coupled to the linear actuator assembly, the rebar tying gun holders configured to each receive a rebar tying gun, wherein the linear actuator assembly is configured to selectively move the rebar tying gun holders bidirectionally and independently from one another in a horizontal direction substantially parallel to a longitudinal direction of the chassis, and wherein the linear actuator assembly is configured to selectively move the rebar tying gun holders bidirectionally in a vertical direction through the central opening to move the rebar tying gun holders toward and away from a position underneath the chassis.

Numerous variations, modifications, and additional embodiments are possible, and accordingly, all such variations, modifications, and embodiments are to be regarded as being within the spirit and scope of the present general inventive concept. For example, regardless of the content of any portion of this application, unless clearly specified to the contrary, there is no requirement for the inclusion in any claim herein or of any application claiming priority hereto of any particular described or illustrated activity or element, any particular sequence of such activities, or any particular interrelationship of such elements. Moreover, any activity can be repeated, any activity can be performed by multiple entities, and/or any element can be duplicated.

It is noted that the simplified diagrams and drawings included in the present application do not illustrate all the various connections and assemblies of the various components, however, those skilled in the art will understand how to implement such connections and assemblies, based on the illustrated components, figures, and descriptions provided herein, using sound engineering judgment. Numerous variations, modification, and additional embodiments are possible, and, accordingly, all such variations, modifications, and embodiments are to be regarded as being within the spirit and scope of the present general inventive concept.

While the present general inventive concept has been illustrated by description of several example embodiments, and while the illustrative embodiments have been described in detail, it is not the intention of the applicant to restrict or in any way limit the scope of the general inventive concept to such descriptions and illustrations. Instead, the descriptions, drawings, and claims herein are to be regarded as illustrative in nature, and not as restrictive, and additional embodiments will readily appear to those skilled in the art upon reading the above description and drawings. Additional modifications will readily appear to those skilled in the art. Accordingly, departures may be made from such details without departing from the spirit or scope of applicant's general inventive concept.

1. A rebar tying system comprising:
a main body with a central opening that passes from top to bottom of the main body;
two or more propulsion members coupled to the main body and configured to propel the rebar tying system over a rebar mat; and
a plurality of rebar tying gun holders coupled to the main body, the rebar tying gun holders configured to each receive a rebar tying gun, and configured to be selectively positionable both horizontally and vertically in the central opening to perform rebar tying operations.

2. The system of claim 1, further comprising a plurality of rebar tying guns respectively received in the rebar tying gun holders.

3. The system of claim 1, further comprising a linear actuator assembly coupled to the main body and the rebar tying gun holders, and configured to position the rebar tying gun holders independently from one another.

4. The system of claim 3, wherein the linear actuator assembly comprises:
a horizontal actuator assembly comprising:
a horizontal support rail configured to be coupled to the main body,
a first horizontal leadscrew,
a first horizontal motor configured rotate the first horizontal leadscrew,
a first horizontal rail coupling member configured be slidably coupled to the horizontal support rail so as to move along the first horizontal leadscrew bidirectionally according a rotational direction of the first horizontal leadscrew, and configured to be coupled to a first one of the rebar tying gun holders,
a second horizontal leadscrew,
a second horizontal motor configured rotate the second horizontal leadscrew, and
a second horizontal rail coupling member configured be slidably coupled to the horizontal support rail so as to move along the second horizontal leadscrew bidirectionally according a rotational direction of the second horizontal leadscrew, and configured to be coupled to a second one of the rebar tying gun holders,
wherein the first and second horizontal leadscrews are substantially aligned along a common longitudinal axis.

5. The system of claim 4, wherein the linear actuator assembly further comprises:
a first vertical actuator assembly comprising:
a first vertical support rail configured to be coupled to the first horizontal rail coupling member,
a first vertical leadscrew,
a first vertical motor configured to rotate the first vertical leadscrew, and
a first vertical rail coupling member configured to be slidably coupled to the first vertical support rail so as to move along the first vertical leadscrew bidirectionally according a rotational direction of the first vertical leadscrew, and configured to be coupled to the first one of the rebar tying gun holders; and
a second vertical actuator assembly comprising:
a second vertical support rail configured to be coupled to the second horizontal rail coupling member,
a second vertical leadscrew,
a second vertical motor configured to rotate the second vertical leadscrew, and
a second vertical rail coupling member configured to be slidably coupled to the second vertical support rail so as to move along the second vertical leadscrew bidirectionally according a rotational direction of the second vertical leadscrew, and configured to be coupled to the second one of the rebar tying gun holders.

6. The system of claim 5, wherein each of the first and second vertical actuator assemblies comprise a rebar gun aligner coupled between the respective vertical rail coupling members and rebar gun holders and configured to selectively rotate the respective rebar gun holders to a desired angle of rotation.

7. The system of claim 6, wherein the rebar gun aligner is arranged as a hinge assembly having a plurality of possible fixed positions.

8. The system of claim 7, wherein a first portion of the hinge assembly comprises a retractable stopping member, and wherein a second portion of the hinge assembly comprise a plurality of openings configured to respectively receive the stopping member to fix a desired rotational angle of the rebar gun holder.

9. The system of claim 1, further comprising a plurality of navigational sensors provided at one or both ends of the main body and configured to detect rebar that is oriented in a direction parallel to a longitudinal axis of the main body.

10. The system of claim 9, wherein each of the navigational sensors are configured to be slidably coupled to the main body so as to be positionally adjustable in a direction lateral to the longitudinal axis of the main body.

11. The system of claim 1, further comprising a plurality of intersection sensors provided proximate a bottom of the central opening and configured to detect rebar that is oriented lateral to a longitudinal axis of the main body.

12. The system of claim 11, wherein each of the intersection sensors are configured to be slidably coupled to the main body so as to be positionally adjustable in a direction parallel to the longitudinal axis of the main body.

13. The system of claim 1, further comprising a plurality of rebar tying gun aligners to which the rebar tying gun holders are respectively attached, the rebar tying gun aligners being configured to angularly position the rebar tying gun holders horizontally at a desired position over the rebar mat.

14. The system of claim 13, further comprising a plurality of vertical linear actuators to which the rebar tying gun aligners are respectively attached, the vertical linear actuators being configured to position the rebar tying gun holders to a desired vertical position.

15. The system of claim 14, further comprising a horizontal linear actuator to which the plurality of vertical linear actuators are respectively attached, the horizontal linear actuator being configured to position the vertical linear actuators to respective desired positions along a horizontal axis.

16. The system of claim 1, wherein the two or more propulsion members are configured as continuous track assemblies provided respectively to each side of the main body.

17. The system of claim 1, further comprising:
a plurality of sensors configured to indicate positioning of the system relative to the rebar mat; and
a controller to receive position signals from the sensors and control movement and positioning operations based thereon.

18. The system of claim 17, wherein the controller is configured to communicate with a remote control to provide various sensor information and to receive various control commands.

19. The system of claim 17, wherein the sensors are slidably mounted to the main body so as to be adjustable to position the respective sensors over respective rebars.

20. A rebar tying system comprising:
a chassis with a central opening that passes through the chassis from top to bottom of the chassis;
continuous track assemblies respectively arranged on two opposing sides of the chassis and configured to propel the rebar tying system over a rebar mat;
a linear actuator assembly coupled to the chassis; and
a plurality of rebar tying gun holders coupled to the linear actuator assembly, the rebar tying gun holders configured to each receive a rebar tying gun;
wherein the linear actuator assembly is configured to selectively move the rebar tying gun holders bidirectionally and independently from one another in a horizontal direction substantially parallel to a longitudinal direction of the chassis, and
wherein the linear actuator assembly is configured to selectively move the rebar tying gun holders bidirectionally in a vertical direction through the central opening to move the rebar tying gun holders toward and away from a position underneath the chassis.
